(19) United States
(12) Patent Application Publication
(10) Pub. No.: US 2023/0243929 A1
(43) Pub. Date: Aug. 3, 2023

(54) LIDAR SYSTEM WITH COARSE ANGLE CONTROL

(71) Applicant: OSRAM GMBH, München (DE)

(72) Inventors: Peter HOHMANN, Berlin (DE); Martin SCHNARRENBERGER, Berlin (DE)

(73) Assignee: LEDDARTECH INC., Quebec City, QC (CA)

(21) Appl. No.: 18/001,253

(22) PCT Filed: Jun. 1, 2021
(86) PCT No.: PCT/EP2021/064693

§ 371 Date: Dec. 8, 2022

(30) Foreign Application Priority Data
Jun. 9, 2020 (DE) 10 2020 207 176.4

(51) Int. Cl. G01S 7/481; G01S 7/4865; G02F 1/1335; G02F 1/1337

(52) U.S. Cl. CPC G01S 7/4815; G01S 7/4865; G02F 1/133541; G02F 1/133769

(57) ABSTRACT

According to various embodiments, a LIDAR system (100) may have: a detector (104) having a plurality of detector pixels (106) arranged along a first direction, wherein each detector pixel (106) of the plurality of detector pixels (106) is assigned to a respective sub-section of the field of view (102); a light source (110) having a plurality of sub-light sources (112) arranged along a second direction at an angle to the first direction, wherein each sub-light source (112) of the plurality of sub-light sources (112) is assigned to a respective sub-section of the field of view (102); a coarse angle control element (114) which is configured to deflect light from the light source (110) to the field of view and to deflect light from the field of view (102) to the detector (104); and a light emission controller (118) which is configured to control the sub-light sources (112) of the plurality of sub-light sources (112) in such a way that each sub-light source (112) of the plurality of sub-light sources (112) emits light in a respective emission time period.

Various exemplary embodiments relate to a LIDAR system (i.e., a Light Detection And Ranging system).

A LIDAR system is a scanning system that illuminates a scene to provide information about the scene, e.g., objects therein (e.g., their size, speed, direction of movement, and the like). An exemplary LIDAR architecture has a fine angle control element (e.g., an Optical Phased Array, OPA) and a (separate) coarse angle control element (e.g., a Liquid Crystal Polarization Grating, LCPG) for controlling a direction of light emitted onto the scene (in other words, for guiding the beam of the light emitted into a field of view of the LIDAR system). In this exemplary architecture, the field of view is divided into a plurality of sections (also referred to as tiles) onto which light may be directed (and from which light may be received).

For example, the LIDAR system may be designed for fields of view of +/-10° to +/-60°, and the LCPG may have 4 to 16 horizontal tiles, through which the measurement system is switched, i.e. the tiles in the field of view are approached one after the other within a LIDAR frame via the LCPG. The LIDAR system may have, for example, 1 to 16 laser diodes as a light source, which may also be designed to be individually switchable. The required resolution in the horizontal direction for a typical LIDAR measurement is about 0.05° to 1°. In the vast majority of cases, it is therefore not sufficient for implementing the horizontal resolution within an LCPG tile with the channels of the laser diodes such that one or more lasers illuminate a column and thus realize the horizontal resolution. Therefore, the fine angle control element is also used for the horizontal resolution, i.e. the horizontal resolution within one of the tiles of the LCPG is implemented with the fine angle control element (e.g., with a one-dimensional MEMS mirror). Illustratively, the fine angle control element is used to implement the fine beam deflection in the horizontal direction. The LIDAR system thus has a component for implementing a fine beam deflection, which increases the complexity of the system, e.g., with regard to the required optics and the required synchronization of the operation of the component with the operation of the light source.

As another example, the LCPG may be used with flash illumination and a two-dimensional detector array of a time-of-flight (ToF) camera. In this configuration, however, the camera’s entire field of view (also referred to as a field of vision) is illuminated at once, resulting in reduced intensity and therefore reduced range.

Various embodiments relate to a LIDAR system in which part of the spatial resolution (e.g., resolution in a first direction) is provided by the emitter side (also referred to as the transmit side) and another part of the spatial resolution (e.g., resolution in a second direction) is provided by the receiver side. In various embodiments, the scanning directions of the emitter and receiver sides of the LIDAR system are swapped so that the transmitter side is used for resolution in one direction (e.g., the vertical direction) and the receiver side for a different direction (e.g., the horizontal direction).

A LIDAR system may be provided in which part of the spatial resolution of a LIDAR measurement (e.g., spatial resolution in a first direction) is provided by the spatial arrangement of a plurality of sub-light sources (e.g., individual laser diodes) of the LIDAR system, and a another part of the spatial resolution of the LIDAR measurement (e.g., spatial resolution in a second direction) is provided by the spatial arrangement of a plurality of detector pixels of a detector of the LIDAR system. Various embodiments relate to a LIDAR system in which the (two-dimensional) spatial resolution of the LIDAR measurement is provided by the arrangement of a plurality of sub-light sources relative to detector pixels.

In the figures, the first direction and the second direction may be represented as the horizontal direction and the vertical direction (or vice versa). However, it is understood that the first direction and the second direction may be any two directions at an angle to each other that enable the sub-light sources to emit light towards the field of view of the LIDAR system and enable the detector pixels to receive light from the field of view of the LIDAR system. To illustrate, the first direction and the second direction may be any two directions along which spatial resolution is to be achieved.

A LIDAR system may have a coarse angle control element for controlling a beam direction of emitted light and/or of received light. The coarse angle control element may be configured to control (e.g., change) the propagation direction of both the light emitted by the LIDAR system into the field of view and the light received by the LIDAR system from the field of view.

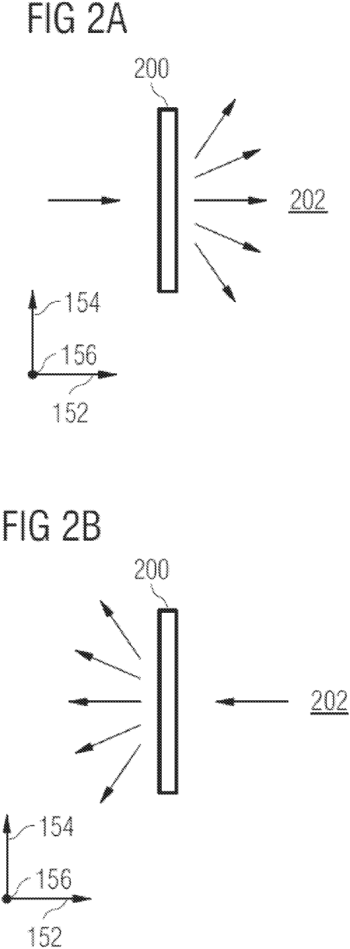

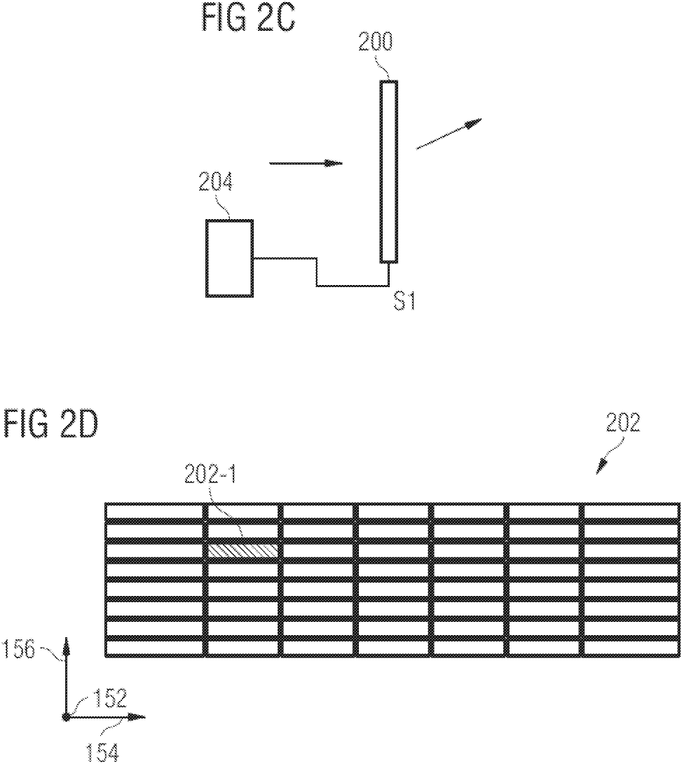

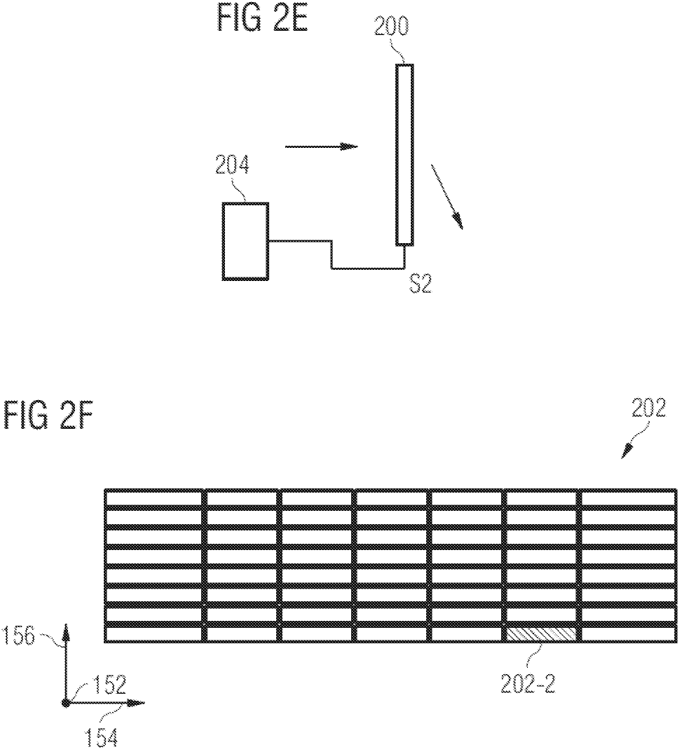

A coarse angle control element may be understood as a device which is configured (e.g., is controllable) in such a way that it controls a propagation direction of the light propagating through (in other words, passing through) the coarse angle control element. Illustratively, the coarse angle control element may be configured to provide a deflection angle (also referred to as a deviating angle) to deflect light propagating through the coarse angle control element (e.g., to provide a controllable output angle). The deflection angle may be defined by the control of one or more properties of the coarse angle control element, such as described with respect to FIGS. 2A to 2F. The coarse angle control element may enable coarse control of the deflection angle such that the deflection angle cannot be varied continuously but may take on one of a plurality of discrete values. The coarse angle control element may be configured (e.g., controlled) to assume one of a plurality of possible operating states, wherein the operating state defines a corresponding deflection angle for the light. The number of possible operating states (the number of possible deflection angles in various aspects) may depend on the properties of the coarse angle control element (e.g., on the number of switchable liquid crystal layers, for example only), as will be explained in more detail below. The coarse angle control element may be or have a liquid crystal polarization grating. However, it should be understood that a liquid crystal polarization grating is just one example of a possible coarse angle control element, and other types of devices may also be used (e.g., a mirror).

In terms of discretely controlling the deflection angle for light emission, the field of view may be considered as being composed of a plurality of tiles (illustratively, a plurality of discrete sections). Each tile may be assigned to a corresponding deflection angle. The term tile (e.g., field-of-view tile or LCPG tile) may be used herein to describe a section of the field of view into which light may be deflected via discrete control over a deflection angle of the emitted light. A tile may further describe a (discrete) section of the field of view from which light may be received (e.g., detected).

The detector may be used for first direction resolution within a tile. The individual sub-light sources or groups of sub-light sources (e.g., laser diodes or groups of laser diodes) may be used for resolution in the second direction within the tile. For example, the detector may be used for resolution in the horizontal direction and the light emitters for resolution in the vertical direction in a case where the field of view of a tile has fewer rows than columns. For example, a receiving diode array (e.g., an avalanche photo diode array, APD) may be available for more rows (e.g., up to 64 or 128) than channels in a laser diode array (e.g., up to 8, 16, or 32, which could significantly increase the complexity and cost).

The relative spatial arrangement of the detector pixels and the sub-light sources, in combination with the angular deflection possibilities of the coarse angle control element, may make it possible to dispense with a fine angle deflection element, e.g., an OPA or a MEMS mirror (only as examples). The spatial resolution within a tile may be achieved in various embodiments by a crossed arrangement of a light source (e.g., a laser bar) and a detector (e.g., a 1D detector array). A sequential use of the sub-light sources (e.g., laser diodes of a laser bar, such as an 8-laser bar or 16-laser bar) may enable a spatial resolution in one direction. To illustrate, the sub-light sources of a light source (e.g., the laser diodes of a laser bar) may be fired (illustratively, activated) one after the other in order to provide the spatial resolution.

This may have the advantage that a complicated component (OPA, MEMS, or the like) may be omitted. This also eliminates the need to control this component (usually implemented with an FPGA or ASIC) and the optics become simpler. There is also no longer the problem that the light from the sub-light sources (e.g., from the lasers) has to fit the fine angle deflection element. The optics consist of fewer lenses, which means that the losses are lower and the assembly effort is reduced. By eliminating the fine angle deflection element, the cost and complexity of the LIDAR system is significantly reduced. In addition, without the fine angle deflection element, there is a real solid state LIDAR that does not require any moving parts, which may also increase reliability.

Various embodiments relate to a LIDAR system in which two-dimensional spatial resolution may be enabled without using a fine angle control element (e.g., without using a MEMS mirror). The LIDAR system may be described in various embodiments as a LIDAR system with LCPG and without MEMS, for example as a flash LIDAR with LCPG.

A LIDAR system may have: a detector which is configured to detect light from a field of view, wherein the detector has a plurality of detector pixels arranged along a first direction, wherein each detector pixel of the plurality of detector pixels is assigned to a respective sub-section of the field of view; a light source having a plurality of sub-light sources which are configured in such a way that they emit light into the field of view, wherein the sub-light sources of the plurality of sub-light sources are arranged along a second direction at an angle to the first direction, wherein each sub-light source of the plurality of sub-light sources is assigned to a respective sub-section of the field of view; a coarse angle control element which is configured to deflect light from the light source (e.g., from the sub-light sources) to the field of view and to deflect light from the field of view to the detector; and a light emission controller which is configured to control the sub-light sources of the plurality of sub-light sources such that each sub-light source of the plurality of sub-light sources emits light in a respective emission time period.

The second direction may be perpendicular to the first direction. As an example, the first direction may be the horizontal direction and the second direction may be the vertical direction. As a further example, the first direction may be the vertical direction and the second direction may be the horizontal direction.

For example, the first direction and the second direction may be perpendicular to an optical axis of the LIDAR system.

The coarse angle control element may be configured to deflect light at a deflection angle with respect to the optical axis of the LIDAR system. The deflection angle may be one of a plurality of discrete deflection angles (e.g., assigned to a respective operating state of the coarse angle control element).

The coarse angle control element may be configured to deflect light from the light source at a first deflection angle to illuminate a section of the field of view. Illustratively, the coarse angle control element may be configured to control a deflection angle (and output angle) of the light emitted into the field of view such that the light is emitted into a section of the field of view. The coarse angle control element may be configured (e.g., controlled) to sequentially provide different deflection angles such that different sections of the field of view are sequentially illuminated.

The coarse angle control element may be configured to deflect light from the field of view at a second deflection angle to deflect light from a section of the field of view onto the detector.

An illuminated section of the field of view may have a first angular extension in a first field-of-view direction of about 2° to about 20° and a second angular extension in a second field-of-view direction perpendicular to the first field-of-view direction of about 2° to about 20°.

The angular extension of a section of the field of view may depend on the properties of the coarse angle control element. The number of sections into which the field of view may be divided (e.g., in the horizontal direction or in the vertical direction) may depend on the properties of the coarse angle control element.

For example, the first field-of-view direction and the second field-of-view direction may be perpendicular to an optical axis of the LIDAR system. As an example, the first field-of-view direction may be the horizontal direction and the second field-of-view direction may be the vertical direction.

Each section (e.g., each tile) of the field of view may be divided into a plurality of sub-sections, e.g., a first plurality of (first) sub-sections in the first direction and a second plurality of (second) sub-sections in the second direction.

A sub-section may be assigned to a respective detector pixel. For example, each sub-section along the direction in which the detector pixels are arranged may be assigned to a respective detector pixel. Illustratively, each detector pixel may detect light from the assigned sub-section. The resolution in the first direction may depend on (e.g., be proportional to) the number of sub-sections (in various aspects, on the number of detector pixels) in the first direction. A sub-section may be assigned to a respective sub-light source. For example, each section may be assigned to a respective sub-light source along the direction in which the sub-light sources are arranged. Illustratively, each sub-light source may emit light into the assigned sub-section. According to various embodiments, the resolution in the second direction may depend on (e.g., be proportional to) the number of sub-sections (in various aspects, on the number of sub-light sources) in the second direction.

To implement the deflection angle, a first deflection-angle element (also referred to as a deflection-angle part or deflection-angle component) may be provided in a first field-of-view direction (e.g., in the horizontal or vertical direction), and a second deflection-angle element may be provided in a second field-of-view direction perpendicular to the first field-of-view direction. Illustratively, the coarse angle control element may be configured to deflect the light in one direction and/or in two directions (e.g., the LIDAR system may be a 1D scanning system or a 2D scanning system).

For numerical example only, the first output angle element may have a value in a range from about -60° to about +60° with respect to the optical axis of the LIDAR system. As a numerical example only, the second output angle element may have a value in a range from about -15° to about +15° with respect to the optical axis of the LIDAR system.

The plurality of sub-light sources may have a first sub-light source and a second sub-light source. The light emission controller may be configured to control the first sub-light source and the second sub-light source such that the first sub-light source emits light in a first emission time period and the second sub-light source emits light in a second emission time period. A waiting time between the first emission time period and the second emission time period is greater than or substantially equal to a maximum transit time of the emitted light.

For example, the second emission time period may follow the first emission time period (and then further emission time periods, e.g., from further sub-light sources).

The waiting time enables the light emitted by the first sub-light source to return to the LIDAR system (and be detected by the detector) before the second sub-light source emits light. As a result, an overlap between the light emissions from different sub-light sources may be reduced or substantially eliminated, and the quality of the measurement may thus be improved.

The LIDAR system may further have an angle controller which is configured to control one or more light deflection properties of the coarse angle control element to define a deflection angle of the deflected light. The angle controller may be configured to control the coarse angle control element to provide a first deflection angle of the deflected light in a first angle-control time period and to provide a second deflection angle of the deflected light in a second angle-control time period. For example, the second angle-control time period may follow the second angle-control time period. For example, the angle controller may be configured to control the light deflection properties of the coarse angle control element in such a way that different deflection angles may be provided one after the other.

The light emission controller may be configured to control the sub-light sources of the plurality of sub-light sources such that each sub-light source emits light in the respective emission time period within the first angle-control time period and that each sub-light source emits light in the respective emission time period within the second angle-control time period.

Illustratively, the light emission controller may be configured to control the sub-light sources of the plurality of sub-light sources in such a way that a section of the field of view (e.g., assigned to the first deflection angle) is completely illuminated (in other words, that each sub-section is illuminated by the assigned sub-light source).

The coarse angle control element may have at least one liquid crystal element. The coarse angle control element may be or have a liquid crystal polarization grating, for example. A grating period of the liquid crystal polarization grating may define the deflection angle.

As another example, the coarse angle control element may have a liquid crystal layer and a polarization grating. The liquid crystal layer may be arranged in such a way that it defines a polarization of the light propagating through the liquid crystal layer. The polarization grating may be configured to define the deflection angle of the light based on its polarization.

The coarse angle control element may be or have a liquid crystal polarization grating. The angle controller may be configured to provide a control signal (e.g., a voltage such as a modulated voltage, for example a DC voltage, which is switched on and off) to the liquid crystal polarization grating to control an alignment of the liquid crystal molecules. The alignment of the liquid crystal molecules defines a grating period of the liquid crystal polarization grating.

For example, the angle controller may be configured to provide a first control signal to the liquid crystal polarization grating in a first angular time period in order to define a first grating period of the liquid crystal polarization grating. The angle controller may be configured to provide a second control signal to the liquid crystal polarization grating in a second angular time period (e.g., after the first angular time period) in order to define a second grating period of the liquid crystal polarization grating. Illustratively, the angle controller may control the grating period of the liquid crystal polarization grating to provide various deflection angles.

The coarse angle control element may have a liquid crystal layer and a polarization grating. The angle controller may be configured to provide a control signal to the liquid crystal layer to control an alignment of the liquid crystal molecules of the liquid crystal layer. The alignment of the liquid crystal molecules defines (e.g., changes) the polarization of light propagating through the liquid crystal layer.

For example, the angle controller may be configured to provide a first control signal to the liquid crystal layer in a first angular time period in order to define a first polarization of the light propagating through the liquid crystal layer. The angle controller may be configured to provide a second control signal to the liquid crystal layer in a second angular time period in order to define a second polarization of the light propagating through the liquid crystal layer. The polarization grating may thus provide a first deflection angle for the light in the first angular time period based on the first polarization and provide a second deflection angle for the light in the second angular time period based on the second polarization.

The light source may have at least one laser light source. For example, the sub-light sources may have at least one laser light source (e.g., each sub-light source may be or have a laser light source). For example, the at least one laser light source may have a laser diode. As an example, the at least one laser diode may be an edge-emitting laser diode or a component-side light emitting diode (Vertical-Cavity Surface-Emitting Laser, VCSEL).

The light source may have a laser bar. Illustratively, the sub-light sources may be laser diodes of the laser bar. For example, a fast axis of the laser bar may be aligned along the direction in which the sub-light sources are arranged (e.g., along the second direction).

The detector may have at least one photodiode. The photodiode may be configured to generate an electrical signal (e.g., a voltage or current) when light strikes the at least one photodiode. For example, each detector pixel may have a photodiode or be assigned (e.g., connected) to a respective photodiode. It is understood that each detector pixel may also have a plurality of photodiodes or may be assigned to a plurality of photodiodes (e.g., in the manner of a silicon photomultiplier). For example, the at least one photodiode may be an avalanche photodiode, e.g., a single-photon avalanche photodiode. Clearly, the detector may be or have a multi-pixel single-photon avalanche photodiode.

The LIDAR system may further have an optical array receiver. The optical array receiver may be configured to receive light from the field of view and direct the received light onto the detector. In various aspects, the optical array receiver may be configured to map the field of view (e.g., a section of the field of view) onto the detector. For example, the optical array receiver may be configured in such a way that it maps a respective sub-section of the field of view onto the assigned detector pixel. For example, the optical array receiver may be arranged between the detector and the coarse angle control element.

The optical array receiver may have one or more lenses (e.g., one or more focusing lenses). The one or more lenses may be configured to focus the received light on the detector (e.g., on the respective detector pixels).

The LIDAR system may further have an optical array transmitter. The optical array transmitter may be configured to receive light from the light source (e.g. from the sub-light sources) and to direct the received light onto the coarse angle control element. For example, the optical array transmitter may be arranged between the light source and the coarse angle control element. The optical array transmitter may have a first collimator lens. The first collimator lens may be configured to collimate the light emitted by the light source onto the coarse angle control element. For example, the first collimator lens may be configured in such a way that it collimates light in a first (optical) direction. For example, the first collimator lens may collimate the light in the direction of the slow axis of the light source, for example in a direction perpendicular to the direction in which the sub-light sources are arranged. For example, the first collimator lens may be a slow-axis collimator (SAC).

The optical array transmitter may have a second collimator lens. The second collimator lens may be arranged between the light source and the first collimator lens. The second collimator lens may be configured in such a way that it collimates the light emitted by the light source onto the first collimator lens. For example, the second collimator lens may be configured in such a way that it collimates light in a second (optical) direction. For example, the second collimator lens may collimate the light in the direction of the fast axis of the light source, for example in a direction perpendicular to the direction in which the sub-light sources are arranged. For example, the second collimator lens may be a fast-axis collimator (FAC) lens.

The optical array transmitter may further have a multi-lens array for mixing the light emitted by each of the plurality of sub-light sources. For example, the multi-lens array may be arranged between the light source and the coarse angle control element (e.g., between the first collimator lens and the coarse angle control element). The multi-lens array may have a zone structure along the second direction (clearly, along the direction in which the sub-light sources are arranged). The zone structure enables the light emitted by one sub-light source to be well separated from the light emitted by another sub-light source.

The LIDAR system may be configured as or be a flash LIDAR system.

A vehicle may have one or more LIDAR systems as described herein.

Exemplary embodiments are illustrated in the figures and will be described in greater detail below.

In the drawings:

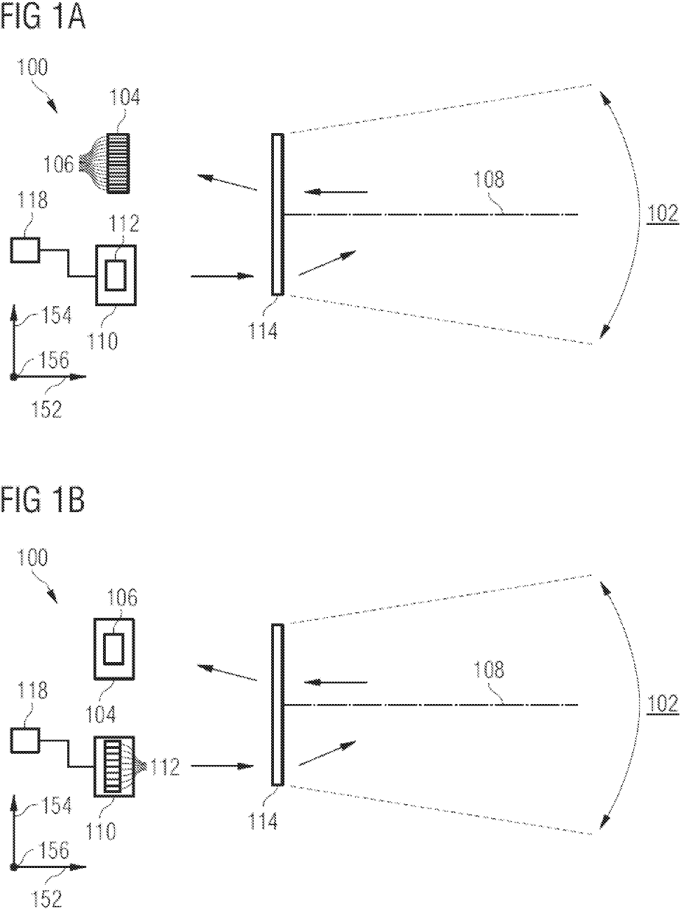

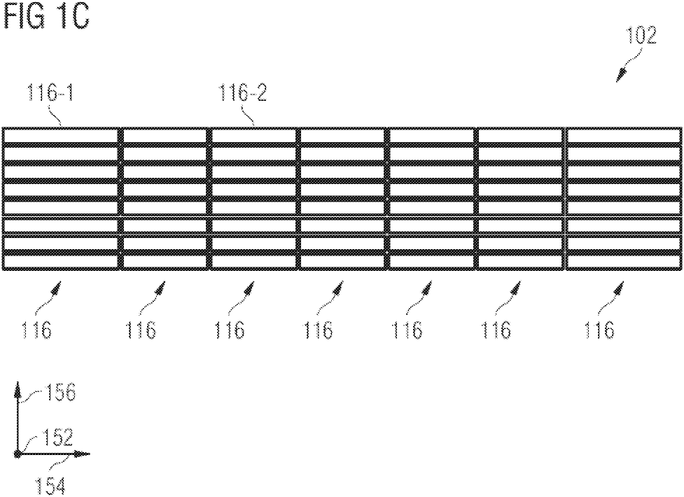

FIGS. 1A and 1B each show a schematic representation of a LIDAR system.

FIG. 1C shows a schematic representation of a field of view of a LIDAR system.

FIGS. 2A and 2B each show a schematic representation of a coarse angle control element.

FIG. 2C shows a first operating mode of a coarse angle control element.

FIG. 2D shows an illuminated field of view in a first operating mode of a coarse angle control element.

FIG. 2E shows a second operating mode of a coarse angle control element.

FIG. 2F shows an illuminated field of view in a second operating mode of a coarse angle control element.

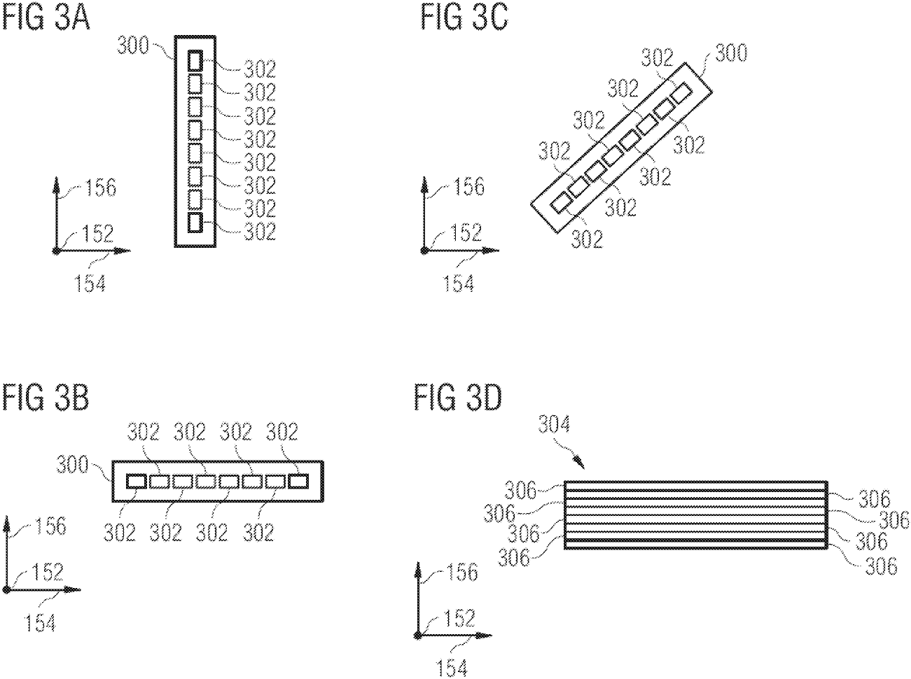

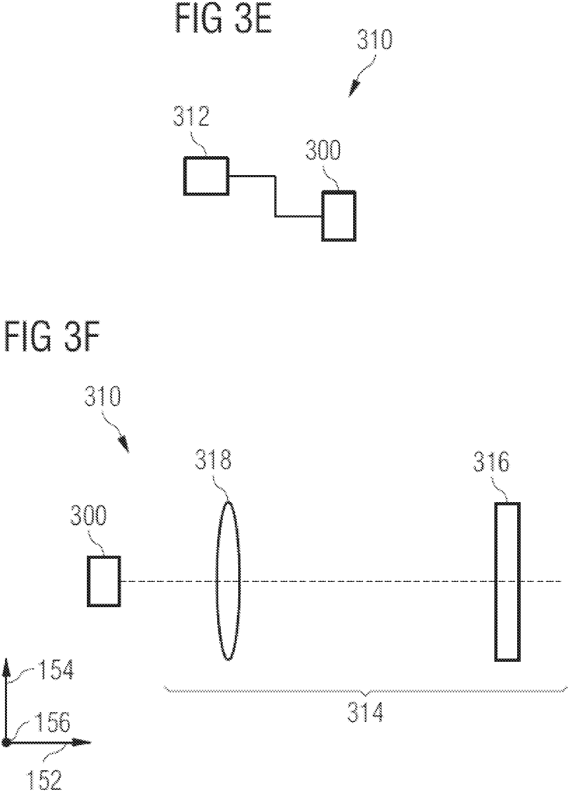

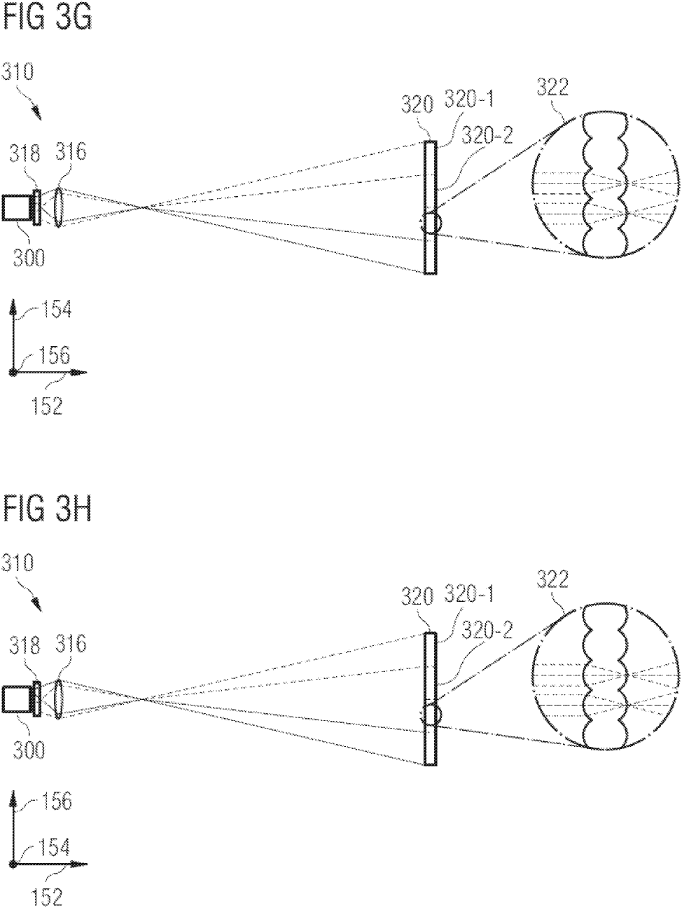

FIGS. 3A to 3C each show a schematic representation of a light source.

FIG. 3D is a schematic representation of a tile of a coarse angle control element.

FIGS. 3E to 3H each show a schematic representation of a light emission system.

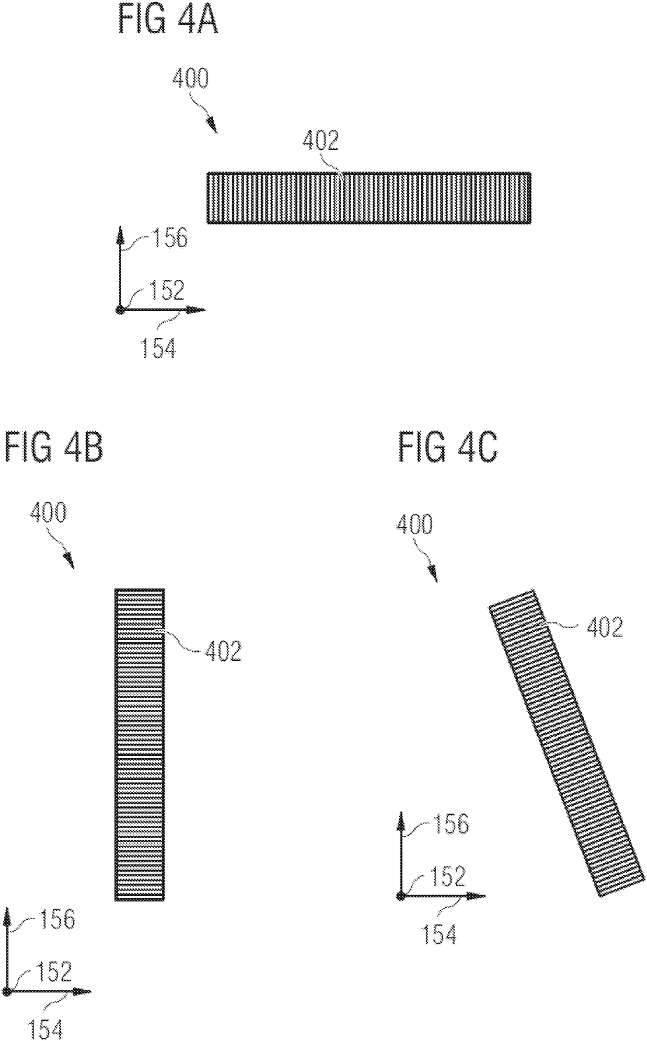

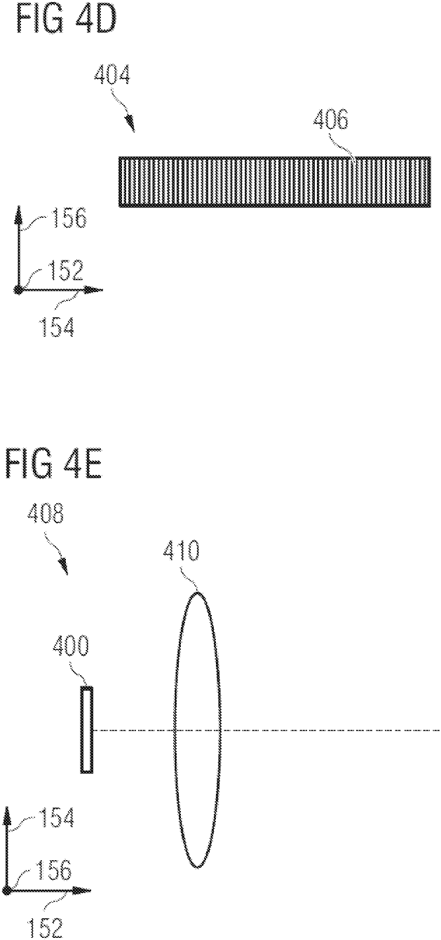

FIGS. 4A to 4C each show a schematic representation of a detector.

FIG. 4D is a schematic representation of a tile of a coarse angle control element.

FIG. 4E shows a schematic representation of a receiver array.

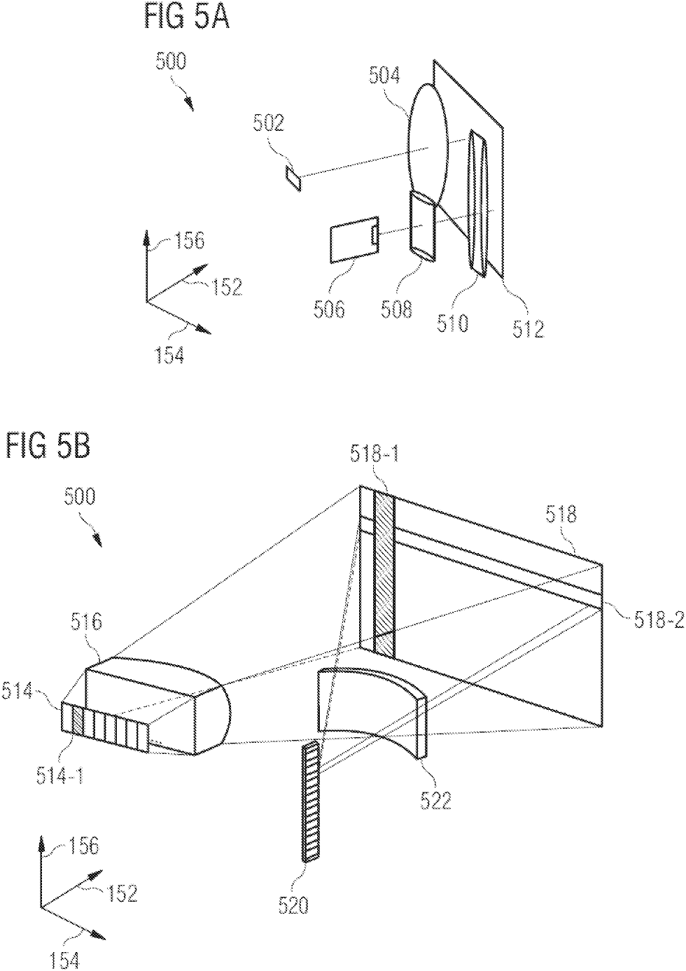

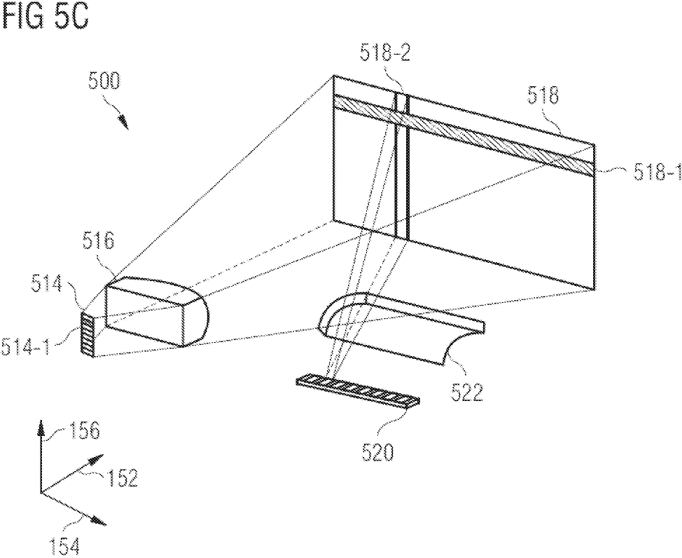

FIGS. 5A to 5C each show a schematic representation of a LIDAR system.

In the following detailed description, reference is made to the accompanying drawings that form a part hereof and in which specific embodiments are shown for illustration, in which the invention may be carried out.

FIGS. 1A and 1B each show a schematic representation of a plan view of a LIDAR system 100 according to various embodiments. As an example, the LIDAR system 100 may be incorporated into (e.g., integrated into) a vehicle (e.g., a car equipped with, for example, automated driving functions).

The LIDAR system 100 may have an emitter side for emitting light into a field of view 102 and a receiver side for receiving (e.g., detecting) light from the field of view 102. The LIDAR system 100 may further have an angle control stage for controlling (e.g., changing) the direction of propagation of the light from the emitter side to the field of view 102 and/or from the field of view 102 to the receiver side.

The field of view 102 may be the field of view of the LIDAR system 100. Illustratively, the field of view 102 may correspond to the emission field of the emitter side (e.g., the emission field of a light source or a plurality of sub-light sources) and/or correspond to the field of view of the receiver side (e.g., the field of view of a detector). Illustratively, the field of view of a detector of the LIDAR system 100 may essentially correspond to the emission field of a light source (e.g., a plurality of sub-light sources) of the LIDAR system 100.

The LIDAR system 100 may have a detector 104 (e.g., on the receiver side, for example, as part of a light detection system). The detector 104 may be configured to detect light from the field of view 102. The detector 104 may be configured to provide a signal (e.g., an electrical signal, such as a voltage or current) when light strikes the detector 104 (e.g., one or more detector pixels), as explained in more detail below (e.g., with reference to FIGS. 4A to 4E).

For example, the signal may be provided from the detector 104 to one or more processors of the LIDAR system 100 (e.g., an analog signal from the detector 104 may be converted to a digital signal using an analog-to-digital converter and provided to the processors). For example, the one or more processors may be configured to analyze the signal (or signals) from the detector 104 to reproduce the scene in the field of view 102.

The detector 104 may have a plurality of detector pixels 106. The detector pixels 106 of the plurality of detector pixels 106 may be arranged along a first direction (e.g., along the horizontal direction as shown in FIG. 1A or along the vertical direction as shown in FIG. 1B). In various embodiments, the detector pixels 106 may form an array along the first direction. At least one detector pixel 106 (e.g., each detector pixel 106) may be configured to generate a signal (e.g., a current, such as a photocurrent) when light strikes the detector pixel 106 (e.g., the signal may be proportional to the amount of incident light), as will be explained in more detail below.

Each detector pixel 106 of the plurality of detector pixels 106 may be assigned to a respective sub-section of the field of view 102. In various aspects, each detector pixel 106 may be dedicated to detecting light from a corresponding sub-section of the field of view 106. To illustrate, each detector pixel 106 may receive light from the corresponding sub-section of the field of view 102 to detect light therefrom. In various aspects, the receiver side (and/or the angle control stage) of the LIDAR system 100 may be configured such that each sub-section of the field of view 102 is mapped onto the corresponding detector pixel 106.

The LIDAR system 100 (e.g., at the emitter side, for example as part of a light emission system) may have a light source 110. The light source 110 may have a plurality of sub-light sources 112 (also referred to as light beams, light emitters, or emitter pixels). In various aspects, the light source 110 may have a plurality of individual light sources 112 that are individually addressable (e.g., controllable), as will be discussed in more detail below, e.g., with respect to FIGS. 3A to 3G. The sub-light sources 112 (generally, the light source 110) may be configured in such a way that they emit light into the field of view 102.

The sub-light sources 112 of the plurality of sub-light sources 112 may be arranged along a second direction. In various aspects, the sub-light sources 112 may form an array in the second direction.

The second direction may be at an angle to the first direction. The angle between the first direction and the second direction cannot be 0° or 180°; in other words, the first direction cannot be parallel to the second direction (illustratively, the second direction cannot be the same direction as the first direction). The first direction and the second direction may be any two directions that form an angle with each other and enable light to be emitted and received. To illustrate, the first direction may be any direction that forms an angle with an optical axis 108 of the LIDAR system 100 and enables the detector 104 to receive light from the field of view 102. The second direction may be any direction that forms an angle with the optical axis 108 of the LIDAR system 100 and enables the light source 110 (e.g., the sub-light sources 112) to emit light toward the field of view 102. In various aspects, the first direction and the second direction may be perpendicular to the optical axis 108 of the LIDAR system 100 (e.g., the optical axis 108 may be aligned along direction 152 in FIGS. 1A and 1B).

In various embodiments, the first direction and the second direction may be perpendicular to one another. For example, the first direction may be the horizontal direction, such as direction 154 in FIGS. 1A and 1B, and the second direction may be the vertical direction, such as direction 156 in FIGS. 1A and 1B. In this case, the detector pixels 106 may be arranged in a row and the light sources 112 in a column (see FIG. 1A). As a further example, the first direction may be the vertical direction and the second direction may be the horizontal direction. In this case, the detector pixels 106 may be arranged in a column and the light sources 112 in a row (see FIG. 1B).

Each sub-light source 112 may be assigned to a respective sub-section of the field of view 102 (or a respective plurality of sub-sections). The sub-light sources 112 may be configured (e.g., arranged) in such a way that each sub-light source 112 illuminates a respective sub-section of the field of view 102 (e.g., a sub-section of a tile, as will be explained in more detail below). In various aspects, the emitter side (and/or the angle control stage) of the LIDAR system 100 may be configured such that each sub-section of the field of view 102 is illuminated by the corresponding sub-light source 112.

The relative spatial arrangement (e.g., crossed arrangement) between the detector pixels 106 and the sub-light sources 112 (and the assignment of detector pixels 106 and sub-light sources 112 to respective sub-sections of the field of view 102) may enable the detector pixels 106 to be used to provide spatial resolution in the first direction and enable the sub-light sources 112 to be used to provide spatial resolution in the second direction.

The LIDAR system 100 (e.g., light emission system) may have a light emission controller 118 (e.g., one or more processors). The light emission controller 118 may be configured to control the light emission of the light source 110. In various aspects, the light emission controller 118 may control the sub-light sources 112 of the plurality of sub-light sources 112 such that each sub-light source 112 emits light in a respective emission time period.

The light emission controller 118 may assign an emission time period to each sub-light source 112 such that a single sub-light source 112 emits light in each emission time period. To illustrate, the light emission controller 118 may be configured to control the sub-light sources 112 in such a way that each sub-light source 112 emits light during the corresponding emission time period and not during the emission time period associated with another sub-light source 112. This may mean that there is essentially no (e.g., temporal and/or spatial) overlap in the light emission of the sub-light sources 112. As a result, any (e.g., predefined) spatial resolution may be achieved in the direction along which the sub-light sources 112 are arranged.

The light emission controller 118 may be configured to control the sub-light sources 112 in such a way that they emit light in coordination (e.g., in synchronization) with a control of a coarse angle control element 114, as will be explained in more detail below.

The LIDAR system 100 may have a coarse angle control element 114 (e.g., at the angle control stage). The coarse angle control element 114 may be configured to deflect light, e.g., both light emitted from the light source 110 into the field of view 102 and light coming from the field of view 102 and heading toward the detector 104 (e.g., toward the receiver side). In other words, the coarse angle control element 114 may be arranged such that it deflects light from the light source 110 (e.g., from the sub-light sources 112) to the field of view 102 (e.g., at a first deflection angle) and such that it deflects light from the field of view 102 to the detector 104 (e.g., at a second deflection angle). The coarse angle control element 114 may be configured to deflect the light at multiple deflection angles (e.g., discrete deflection angles), such as described with respect to FIGS. 2A to 2F.

According to various embodiments, the coarse angle control element 114 may be configured to deflect light from the sub-light sources 112 into the field of view 102 at a (e.g., discrete) deflection angle such that a section of the field of view 102 is illuminated. Illustratively, the coarse angle control element 114 may be configured to control a deflection angle (and an output angle) of the light emitted into the field of view 102 such that the light is emitted into a section of the field of view 102. The coarse angle control element 114 may be configured (e.g., controlled) to sequentially provide different deflection angles such that different sections of the field of view 102 are sequentially illuminated, as will be explained in more detail below.

The field of view 102 may be understood as having a plurality of sections (tiles), which are each assigned to a corresponding deflection angle. An exemplary division of the field of view 102 into a plurality of sections 116 is illustrated in FIG. 1C, according to various embodiments.

The field of view 102 may have a first plurality of sections along the first direction and a second plurality of sections along the second direction (e.g., may be divided into the first plurality and the second plurality of sections). As a non-limiting example, as illustrated in FIG. 1C, the field of view 102 may be described as a matrix of tiles 116 arranged along the horizontal direction and the vertical direction (e.g., the field of view 102 may be divided into a plurality of rows and columns, each of which is assigned a plurality of tiles 116). It is understood that the division of the field of view 102 (e.g., the arrangement of the tiles 116) may have any shape and configuration, e.g., depending on the relative arrangement of the first direction with respect to the second direction.

According to various embodiments, the number of tiles 116 into which the field of view 102 is divided (e.g., the number of tiles 116 in the first direction and in the second direction) may depend on the configuration of the LIDAR system 100, e.g., on the configuration of the coarse angle control 114. The angular extension of the field of view 102 in the first direction and in the second direction may depend on the configuration of the LIDAR system 100. As a numerical example only, the field of view 102 may have an angular extension with a value in a range from 100° to 130° in the horizontal direction (e.g., 120°, i.e. from +/-60° with respect to the optical axis 108). As another numerical example, the field of view 102 may have an angular extension with a value in a range of 10° to 60° in the vertical direction (e.g., 20°, i.e. from +/-10° in relation to the optical axis 108, or 24°).

As a numerical example only, as shown in FIG. 1C, the field of view 102 may have seven tiles arranged in the horizontal direction and eight in the vertical direction. As another numerical example, the field of view 102 may have eight tiles in the horizontal direction and four tiles in the vertical direction. As another numerical example, the field of view 102 may comprise eight tiles in the horizontal direction and six tiles in the vertical direction.

The size, e.g., angular extension, of a tile 116 may depend on the properties of the coarse angle control element 114 (e.g., the angles achievable with the coarse angle control element 114).

The tiles 116 may all be the same size (e.g., have the same angular extension in the first direction and in the second direction). In various aspects, at least one tile 116 may have a different size relative to another tile 116. For example, a tile 116 at an edge of the field of view 102 may have a larger size than a tile 116 in the center of the field of view 102 (e.g., a larger angular extension, e.g., in the horizontal direction, as is shown in FIG. 1C for a first tile 116-1 with a larger size than a second tile 116-2).

As a numerical example, a tile 116 may have a first angular extension in a first field-of-view direction (e.g., the first direction) with a value in a range from about 2° to about 20°. For example, a tile 116 may have an angular extension in the horizontal direction of about 4°, for example about 7.5°, for example about 15°.

As a numerical example, a tile 116 may have a second angular extension in a second field-of-view direction (e.g., perpendicular to the first field-of-view direction, such as in the second direction) with a value in a range from about 2° to about 20°. For example, a tile 116 may have an angular extension in the vertical direction of about 2.5°, for example about 4°, for example about 6°, for example about 15°.

Each each tile 116 of the field of view 102 may be divided into a plurality of sub-sections, e.g. into a first plurality of (first) sub-sections in the first direction and into a second plurality of (second) sub-sections in the second direction.

The spatial resolution of the LIDAR system 100 in one direction (e.g., in the first and/or the second direction) may depend on the angular extension of a tile 116 along that direction and on the number of detector pixels 112 or sub-light sources 116 arranged along that direction. The resolution of the LIDAR system 100 may be calculated in a direction by dividing the angular extension of a tile 116 along that direction by the number of sub-light sources 112 or detector pixels 106 arranged along that direction. Illustratively, the number of sub-light sources 112 or detector pixels 106 arranged along a direction may correspond to the number of sub-sections into which a tile 116 may be divided in this direction.

As a numerical example, in the event that a tile 116 has an angular extension of 15° in the horizontal direction and 64 detector pixels 106 are arranged in this direction, a resolution of about 0.23° may be achieved in this direction. As another numerical example, in the event that a tile 116 has an angular extension of 2.5° in the vertical direction and 8 sub-light sources 112 are arranged in this direction, a resolution of about 0.31° may be achieved in this direction. As another numerical example, in the event that a tile 116 has an angular extension of 7.5°x4°, the detector 104 has 64 detector pixels 106 arranged in the horizontal direction and the light source 110 has 16 sub-light sources 112 arranged in the vertical direction, a horizontal resolution of about 0.12° and a vertical resolution of about 0.25° may be achieved. As another numerical example, in the event that a tile 116 has an angular extension of 4°x6°, the detector 104 has 32 detector pixels 106 arranged in the vertical direction and the light source 110 has 16 sub-light sources 112 arranged in the horizontal direction, a horizontal resolution of about 0.25° and vertical resolution of about 0.19° may be achieved.

The coarse angle control element 114 may be configured to deflect light from the field of view 102 to the detector 104 at a second deflection angle. The coarse angle control element 114 may be configured to receive light from the field of view 102 and deflect the received light to the receiver side of LIDAR system 100 (e.g., to an optical array receiver, such as described with respect to FIG. 4E).

The first deflection angle may have the same value as the second deflection angle (e.g., with respect to the optical axis 108, e.g., in the horizontal direction and/or in the vertical direction). In various aspects, the first deflection angle may have a different value compared to the second deflection angle, e.g., depending on the direction of the incident light and/or on a state of the coarse angle control element 114.

FIGS. 2A and 2B each show a schematic representation of a coarse angle control element 200 (e.g., the coarse angle control element 114 shown in FIGS. 1A and 1B).

The coarse angle control element 200 may be configured to deflect light in multiple directions, as illustrated by the arrows in FIGS. 2A and 2B, e.g. to deflect light with multiple deflection angles. The deflected light may be deflected (see FIG. 2A) to a field of view 202 (e.g., a field of view of a LIDAR system, e.g., to a field of view 102 of LIDAR system 100) to illuminate a section of a field of view 202, for example. The deflected light may be light received from a field of view 202, e.g., to deflect onto a detector of a LIDAR system (e.g., detector 104 of LIDAR system 100), see FIG. 2B. In various aspects, the coarse angle control element 200 may be configured to deflect light at a deflection angle independent of the direction in which the light is propagating. The deflection angle may be an angle relative to an optical axis of the coarse angle control element 200 (e.g., relative to an optical axis of a LIDAR system, e.g., the optical axis 108 of the LIDAR system 100).

The deflection angle may be selected from a plurality of (discrete) deflection angles. In other words, the coarse angle control element 200 may be configured (e.g., controlled) to provide a deflection angle from a set of possible deflection angles. In various aspects, each deflection angle may be assigned to a respective operating state of the coarse angle control element 200. An angular resolution of the coarse angle control element 200 (e.g., a minimum difference between possible deflection angles) may depend on the characteristics of the coarse angle control element 200. For example, the coarse angle control element 200 may have an angular resolution (e.g., in the horizontal and/or vertical direction) of 10°, for example 5°, for example greater than 1°, or greater than 3°. As another example, the coarse angle control element 200 may have an angular resolution in a range from about 1° to about 15°. As a numerical example only, the coarse angle control element 200 may have an angular resolution of 7.5° in the horizontal direction and 6° in the vertical direction.

The coarse angle control element 200 may be configured to direct light in one direction and/or in two directions. The deflection angle may have a first deflection-angle element in a first field-of-view direction (e.g., the horizontal or vertical direction) and a second deflection-angle element in a second field-of-view direction at an angle to the first field-of-view direction (e.g., perpendicular to the first field-of-view direction). For example, the first field-of-view direction and the second field-of-view direction may be perpendicular to the optical axis of the coarse angle control element 200.

The range of a value of a deflection-angle element in a direction may define the angular extension of the field of view 202 in that direction. As an example, the first output angle element may have a value in a range from about -60° to about +60° with respect to the optical axis of the coarse angle control element 200. As a further example, the second output angle element may have a value in a range from about -15° to about +15° with respect to the optical axis of the coarse angle control element 200.

An angle controller 204 may be configured to control the coarse angle control element 200, as illustrated in FIGS. 2C and 2E. For example, angle controller 204 may be part of a LIDAR system, such as LIDAR system 100.

The angle controller 204 may be configured to control one or more light deflection properties of the coarse angle control element 200 to define a deflection angle of the deflected light. The angle controller 204 may be configured to place the coarse angle control element 200 into an operating state in order to provide the assigned deflection angle.

The angle controller 204 may be configured to provide (e.g. supply) a control signal (e.g. a control voltage) to the coarse angle control element 200 in order to place the coarse angle control element 200 into an operating state (e.g., assigned to the control signal). For example, the angle controller 204 may be configured to provide one of a plurality of control signals to the coarse angle control element 200 to place the coarse angle control element 200 in one of a plurality of operating states.

The angle controller 204 may be configured to provide a first control signal S1 to the coarse angle control element 200 to define a first deflection angle (e.g., to illuminate a first tile 202-1 of the field of view 202), as illustrated in FIGS. 2C and 2D. The angle controller 204 may be configured to provide a second control signal S2 to the coarse angle controller 200 to define a second deflection angle (e.g., to illuminate a second tile 202-2 of the field of view 202), as illustrated in FIGS. 2E and 2F.

In FIGS. 2C to 2F, the angle controller 204 is shown providing a control signal to the coarse angle control element 200 to illuminate different sections of the field of view 202. It is understood that a similar process may be performed in the case of light received from the field of view 202 (and deflected onto a detector, for example).

According to various embodiments, the angle controller 204 may be configured to control the coarse angle control element to provide a deflection angle in a respective time period (also referred to as an angle-control time period). The angle controller 204 may be configured to control the coarse angle control element to provide a plurality of deflection angles in a plurality of respective angle-control time periods (e.g., sequentially), e.g., to sequentially illuminate different tiles of the field of view 102.

The angle controller 204 may be configured to control the coarse angle control element 200 such that it provides a first deflection angle of the deflected light in a first angle-control time period (e.g., to illuminate a first tile 202-1 of the field of view 202); see, for example, FIG. 2D. The angle controller 204 may be configured to control the coarse angle control element 200 such that it provides a second deflection angle of the deflected light in a second angle-control time period (e.g., to illuminate a second tile 202-2 of the field of view 202); see, for example, FIG. 2F. For example, the second angle-control time period may follow the second angle-control time period (and thereafter further angle-control time periods with further deflection angles may follow). Illustratively, the angle controller 204 may control the coarse angle control element such that the tiles are illuminated sequentially. The order in which the tiles are illuminated may correspond to any desired illumination pattern. For example, the tiles may be illuminated sequentially along the same column or same row. In the event that the element is or has an LCPG, the tiles may be illuminated in a manner that reduces (e.g., minimizes) the number of slow transitions in the liquid crystals.

Operation of the angle controller 204 may be consistent with light emission, e.g., operation of a light emission controller (e.g., light emission controller 118 of LIDAR system 100), as discussed in more detail below. The angle controller 204 may be configured to change the operating state of the coarse angle control element 200 (and the deflection angle) after the tile of the field of view assigned to the current operating state has been fully illuminated (e.g., by each sub-light source 112 of the LIDAR system 100). In other words, the coarse angle control element (e.g., the LCPG) only switches to the next tile when all sub-light sources (e.g., laser diodes) have successively illuminated an entire tile at least once.

The coarse angle control element 200 may have at least one (e.g., switchable) liquid crystal element. For example, the liquid crystal element may have a layer with liquid crystal molecules, which is arranged between two electrodes (e.g., two ITO electrodes), e.g., on a glass substrate.

In various aspects, the coarse angle control element 200 may have a plurality of liquid crystal elements. Each liquid crystal element may define a respective partial deflection angle, as will be explained in more detail below. The deflection angle of the coarse angle control element 200 may be defined by a combination (e.g., a sum) of the plurality of partial deflection angles.

The coarse angle control element 200 may have a lambda/4-plate which is arranged upstream of the (first) liquid crystal element in order to convert linearly polarized light into circularly polarized light.

The coarse angle control element 200 (e.g., the at least one liquid crystal element) may be or have a liquid crystal polarization grating (e.g., a switchable nematic liquid crystal polarization grating, e.g., having a photopolymerizable polymer). A grating period of the liquid crystal polarization grating may define the deflection angle.

The liquid crystal may be periodically poled and have a grating structure which is defined by the orientation of the liquid crystal molecules. The alignment of the liquid crystal molecules may define (e.g., control or change) the deflection angle of the light propagating through the liquid crystal polarization grating. The liquid crystal polarization grating may be arranged to deflect or transmit light in three possible directions (in different aspects, with three possible deflection angles) depending on the grating period and on the polarization of the incident light.

In a first operating state, if no voltage (e.g., control voltage) is applied to the liquid crystal polarization grating, the incident light is deflected in a first direction or in a second direction depending on its polarization (e.g., depending on the polarization state, for example right- or left-circular). The light is deflected at a first deflection angle or at a second deflection angle (e.g., opposite the first deflection angle with respect to an optical axis of the grating). In this case, the polarization of the output light is also reversed to the opposite orthogonal polarization (e.g., from right-circular to left-circular or vice versa). In a second operating mode, upon application of a voltage, the grating period (in some aspects, the grating profile) is quenched and the incident light is allowed to pass through substantially unchanged (e.g., at a third deflection angle having a value of essentially 0°).

The angle controller 204 may be configured to control the liquid crystal polarization grating. The angle controller 204 may be configured to provide a control signal (e.g., a voltage, e.g., other than a DC voltage) to the liquid crystal polarization grating to control the orientation of the liquid crystal molecules (e.g., one or more grating properties of the liquid crystal polarization grating).

For example, the angle controller 204 may be configured to provide a first control signal (e.g., a first control voltage) to the liquid crystal polarization grating in a first angular time period to define a first grating period of the liquid crystal polarization grating (e.g., the presence of a grating period). The angle controller 204 may be configured to provide a second control signal (e.g., a second control voltage) to the liquid crystal polarization grating in a second angular time period in order to define a second grating period of the liquid crystal polarization grating (e.g., the absence of a grating period). As an example, the first control voltage may have a value of 0 V, so that the respective grating property may provide a (first or second) deflection angle depending on the polarization of the light. As another example, the second control voltage may have a value greater than the value of the first control voltage in order to quench the grating period, allowing light to pass through the grating unaltered.

Illustratively, the angle controller 204 may control the grating period of the liquid crystal polarization grating to provide various deflection angles.

In some aspects, the liquid crystal polarization grating may have a plurality of liquid crystal polarization gratings. Each liquid crystal polarization grating may be configured to deflect the light in three directions respectively. Each liquid crystal polarization grating may both add and subtract from the deflection angle, which may provide a larger range of angles. The number of possible deflection angles may thus depend on the number of liquid crystal polarization gratings. In this configuration, the control voltage may have a plurality of control voltages applied to the plurality of liquid crystal polarization gratings in order to individually control the grating properties thereof.

According to various embodiments, the coarse angle control element 200 may have a liquid crystal layer and a polarization grating. The liquid crystal layer may be arranged in such a way that it defines a polarization of the light propagating through the liquid crystal layer. The alignment of the liquid crystal molecules defines (e.g., changes) the polarization of light propagating through the liquid crystal layer. Clearly, the liquid crystal layer may be configured as a switchable polarization selector, for example as a switchable half-wave plate. The liquid crystal layer may have a first state in which it does not change the polarization of light and a second state in which it reverses the polarization of light (e.g., from right-circular to left-circular or vice versa). The polarization grating may be configured to define the deflection angle of the light based on its polarization.

The angle controller 204 may be configured to provide a first control signal (e.g., a first control voltage, e.g. 0 V) to the liquid crystal layer in a first angle-control time period in order to define a first polarization of the light propagating through the liquid crystal layer (in other words, to place the liquid crystal layer into the first state). The angle controller 204 may be configured to provide a second control signal (e.g., a second control voltage, e.g., greater than the first control voltage) to the liquid crystal layer in a second angle-control time period in order to define a second polarization of the light propagating through the liquid crystal layer (in other words, to place the liquid crystal layer into the second state).

The polarization grating may thus provide a first deflection angle for the light in the first angle-control time period based on the first polarization and provide a second deflection angle for the light in the second angle-control time period based on the second polarization.

According to various embodiments, the coarse angle control element 200 may have a plurality of liquid crystal layers and/or have a plurality of polarization gratings (e.g., stacked or laminated, one after the other) in order to increase the range of possible deflection angles (in a similar manner to that described for the liquid crystal polarization grating above).

The number and the horizontal and vertical angular extension (also referred to as angular range) of the tiles may be chosen by the design of the liquid crystal element. The number of tiles may be proportional to the number of liquid crystal layers, e.g., the number of controllable (switchable) layers. By way of numerical example only, a liquid crystal element may be arranged to provide more than 20 tiles, e.g., more than 30 tiles, e.g., more than 50 tiles. The maximum number of tiles may be limited by the switching time of the liquid crystal element (e.g., the liquid crystal polarization grating switching times).

FIGS. 3A to 3C each show a light source 300 in a schematic representation, according to various embodiments. The light source 300 may be a light source for a LIDAR system, e.g., the light source 110 may be of the LIDAR system 100.

The light source 300 may have a plurality of sub-light sources 302 (e.g., the sub-light sources 112 of the LIDAR system 100). The sub-light sources 302 of the plurality of sub-light sources 302 may be arranged in one direction (e.g., next to one another).

The sub-light sources 302 may be arranged in the vertical direction (see FIG. 3A) or arranged in the horizontal direction (see FIG. 3B). In various aspects, the sub-light sources 302 may be arranged in a direction that forms an angle other than 90° with an optical axis of the light source 300 (e.g., with an optical axis of a LIDAR system). As shown by way of example in FIG. 3C, the sub-light sources 302 may be arranged in a 45° direction as relates to the optical axis.

The plurality of sub-light sources 302 may have any number of sub-light sources 302, for example 8 sub-light sources, 16 sub-light sources, or 32 sub-light sources. The number of sub-light sources 302 may determine a resolution in the direction in which the sub-light sources 302 are arranged. As an example, in the event that eight sub-light sources 302 are arranged in the vertical direction, a section 304 of a field of view (such as shown in FIG. 3D) into which the sub-light sources 302 emit light may have eight sub-sections 306. Each sub-section 306 may be illuminated by a respective light source 302. If the section 304 has an angular extension of 15° in the horizontal direction and 2.5° in the vertical direction, each sub-light source 302 may illuminate a sub-section 306 that has an angular extension of 15° in the horizontal direction and 0.31° in the vertical direction. Illustratively, each sub-light source 302 may completely illuminate a section 304 in the direction perpendicular to the direction in which the sub-light sources 302 are arranged. Each sub-light source 302 may illuminate a sub-section 306 in the direction in which the sub-light sources 302 are arranged.

A sub-section 306 may illustratively be understood as a pixel which is illuminated by a respective sub-light source 302. If the field of view is divided into 8 tiles in the vertical direction and each tile is divided into 8 sub-sections 306, 64 pixels may be specified, just as a numerical example.

The light source 300 (for example at least one sub-light source 302, for example each sub-light source 302) may be configured to emit light in the visible and/or infrared wavelength range. For example, the light source 300 may be configured to emit light in the wavelength range from about 700 nm to about 2000 nm, for example at 905 nm or at 1550 nm.

The light source 300 may have at least one laser light source. For example, the sub-light sources 302 may have at least one laser light source (e.g., each sub-light source may be or have a laser light source).

The at least one laser light source may have a laser diode. As an example, the at least one laser diode may be an edge-emitting laser diode or a device-side light-emitting diode.

The light source 300 (e.g., the at least one laser light source) may have a laser bar. Illustratively, the sub-light sources 302 may be laser diodes of the laser bar. For example, a fast axis of the laser bar may be aligned along the direction in which the sub-light sources 302 are arranged. As a numerical example only, the laser bar may have an active area that is 0.1 mm in size in the horizontal direction and 0.48 mm in the vertical direction.

The light source 300 may be part of a light emission system 310 as illustrated in FIGS. 3E, 3F, 3G, and 3H (e.g., the light emission system 310 may be a light emission system of the LIDAR system 100).

The light emission system 310 may have a light emission controller 312 to control the light source 300 (e.g., the plurality of sub-light sources 302). The light emission controller 312 may be an example of a light emission controller 118 of the LIDAR system 100.

The light emission controller 312 may be configured to control the plurality of sub-light sources 302 such that the sub-light sources 302 emit light sequentially (e.g., each in a respective emission time period). Illustratively, the operating mode may be such that only a single sub-light source 302 (e.g., a single laser diode) pulses and illuminates a strip (e.g., a sub-section, for example in the horizontal direction). The spatial resolution within this strip is acquired by a detector (e.g., a row of detectors), as will be explained in more detail with reference to FIGS. 4A to 4E.

The light emission controller 312 may be configured to control a first sub-light source and a second sub-light source in such a way that the first sub-light source emits light in a first emission time period (e.g., assigned to the first sub-light source) and the second sub-light source emits light in a second emission time period (e.g., assigned to the second sub-light source). The second emission time period may follow the first emission time period (e.g., immediately after the first emission time period, with no further emission time periods in between).

The light emission controller 312 may be configured in such a way that it waits a waiting time after a sub-light source 302 has emitted light before it controls the next sub-light source 302 to emit light (e.g., after the first sub-light source has emitted light before it controls the second sub-light source to emit light). The waiting time between successive emission time periods (e.g., between the first emission time period and the second emission time period) may be equal to or greater than a maximum transit time of the emitted light (e.g., than a maximum transit time of a LIDAR system in which the light emission system is contained, such as the LIDAR system 100).

The maximum transit time may be calculated as 2*dₘₐₓ/c, where dₘₐₓ is the maximum range of the LIDAR system (in various aspects, a maximum distance from the system in which an object is contained and still can be detected), and c is the speed of light. As a numerical example, a waiting time may be greater than 100 ns, for example greater than 1 µs, for example greater than 2 µs (corresponding to a maximum range of around 300 m). This may result in a detector of the LIDAR system (e.g., detector 104 of LIDAR system 100) being able to distinguish which pulse is being received.

The light emission controller 312 may be configured to control the sub-light sources 302 in accordance with an angle controller of a LIDAR system (e.g., angle controller 204).

The light emission controller 312 may be configured to control the sub-light sources 302 such that each sub-light source 302 emits light for each deflection angle which is provided by a coarse angle control element (e.g., by coarse angle control element 118) of the LIDAR system. For example, each sub-light source 302 may be controlled to emit light in an angle-control time period defined by the angle controller. As an example, the light emission controller 312 may be configured to control the sub-light sources 302 such that each sub-light source 302 emits light in the respective emission time period within a first angle-control time period, and that each sub-light source 302 emits light in the respective emission time period within a second angle-control time period.

The light emission system 310 may have an optical array (e.g., an optical array transmitter 314), as illustrated in FIGS. 3F to 3H. The optical array transmitter 314 may be arranged downstream of the light source 300, e.g., between the light source 300 and the field of view. For example, the optical array transmitter 314 may be arranged between the light source 300 and a coarse angle control element (e.g., coarse angle control element 118) to direct (e.g., focus or collimate) light from the light source 300 to the coarse angle control element. The optical array transmitter 314 may have one or more lenses, such as one or more collimator lenses (also referred to as collimation lenses).

The optical array transmitter 314 may have a first collimator lens 316 (e.g., a first cylindrical lens) to collimate the light emitted by the light source 300 onto a field of view (e.g., onto a coarse angle control element). For example, the first collimator lens 316 may be a slow-axis collimator lens in order to collimate the emitted light in the direction of the slow axis of the light source 300. As a numerical example, the first collimator lens 316 may have a focal length of about 44 mm.

The first collimator lens 316 may collimate the light such that the collimated light fills only a sub-section of a tile of the field of view in the direction in which the light is collimated by the first collimator lens 316. For example, the first collimator lens 316 may reduce the beam expansion to the required (e.g., horizontal) angle (e.g., 7.5°).

The optical array transmitter 314 may have a second collimator lens 318 (e.g., a second cylindrical lens). The second collimator lens 318 may be arranged between the light source 300 and the first collimator lens 316 in order to collimate the light emitted from the light source 300 onto the first collimator lens 316. For example, the second collimator lens 318 may be a fast-axis collimator lens to collimate the emitted light in the fast-axis direction of the light source 300. The second collimator lens 318 may be configured for beam shaping. As a numerical example, the second collimator lens 318 may have a focal length of about 38 µm.

It is understood that the focal length of the first collimator lens 316 and the second collimator lens 318 may be selected (e.g., adjusted) according to the size of the light source 300, e.g., the width of the active area of a laser bar.

The optical array transmitter 314 may have a multi-lens array 320 as shown in FIG. 3G (for sub-light sources such as four laser diodes arranged in the vertical direction) and in FIG. 3H (for sub-light sources arranged in the horizontal direction). The multi-lens array may be configured to mix the light emitted by each sub-light source of the plurality of sub-light sources. The multi-lens array 320 may be arranged downstream of the first collimator lens 316, e.g., between the first collimator lens 316 and a coarse angle control element (e.g., coarse angle control element 118).

The multi-lens array 320 may have a zone structure (as shown in inset 322), e.g., a plurality of zones (e.g., a first zone 320-1 and a second zone 320-2). The multi-lens array 320 may cause strong (in other words, sharp) separation of the light emitted from the sub-light sources 302. The zone structure may be arranged in the direction in which the plurality of sub-light sources 302 are arranged (e.g., in the vertical direction in FIG. 3G or in the horizontal direction in FIG. 3H). The multi-lens array 320 may cause an increase in the virtual source size and thus provide increased eye safety, for example when light is emitted in the infrared range.

FIGS. 4A to 4C each show a detector 400 in a schematic representation. The detector 400 may be a detector for a LIDAR system, e.g., the detector 104 may be from LIDAR system 100. The detector 400 may be configured to detect light from a field of view (e.g., from the field of view of the LIDAR system). The detector 400 may have a plurality of detector pixels 402 (e.g., the detector pixels 106 of the LIDAR system 100). The detector pixels 402 of the plurality of detector pixels 402 may be arranged in one direction (e.g., side-by-side).

The detector pixels 402 may be arranged in the horizontal direction (see FIG. 4A) or in the vertical direction (see FIG. 4B). The detector pixels 402 may be arranged in a direction that forms an angle other than 90° with an optical axis of the detector 400 (e.g., with an optical axis of a LIDAR system). As shown by way of example in FIG. 4C, the detector pixels 402 may be arranged in a direction at 45° to the optical axis. The plurality of detector pixels 402 may have any number of detector pixels 402, for example 64 detector pixels or 128 detector pixels.

The size of the detector 400 may correspond to the size of a tile 404 of the field of view (such as shown in FIG. 4D) from which the detector 400 detects light. As a numerical example only, the detector 400 (e.g., a 1x64 pixel APD array) may have dimensions of 2.5 mm x 15 mm, which corresponds to a tile 404 (also referred to as a cell) measuring 15° horizontally x 2.5° vertically. Illustratively, the detector 400 may have the same aspect ratio as a tile 404 (e.g., like an LCPG cell).

The number of detector pixels 402 may determine a resolution in the direction in which the detector pixels 402 are arranged. As a numerical example, in a case where 64 detector pixels 402 are arranged in the horizontal direction (e.g., in a 64-pixel APD array), each detector pixel 402 can map 1/64 of the 15°-wide tile 404 horizontally and the entire 2.5° of the tile 404 vertically. Illustratively, each detector pixel 402 may detect light from a sub-section 406 of the tile 404. A horizontal resolution of about 0.23° may be achieved in this configuration. The resolution may be increased if 128 detector pixels 402 are used (e.g., in a 128 pixel APD array).

The detector 400 may have a plurality of detectors (e.g., sub-detectors). For example, multiple detectors may be used to detect light from the field of view. The detectors may be arranged side-by-side, e.g., each detector may be assigned to a respective column or row of the field of view (in order to detect light from the respective column or row). For example only, the detector 400 may have seven detectors, wherein each detector has 64 detector pixels, so that 448 pixels may be used to detect the light (in the horizontal or vertical direction).

The detector 400 (e.g., the detector pixels 402) may have at least one photodiode. For example, at least one (e.g., each) detector pixel 402 may have a photodiode or be coupled to a respective photodiode. For example, the at least one photodiode may be an avalanche photodiode, e.g., a single-photon avalanche photodiode. For example, the detector 400 may be or have an APD row or an SPAD row. Illustratively, the detector 400 may be or have a multi-pixel single-photon avalanche photodiode.

An optical array receiver 408 may be used to map the field of view onto the detector 400, as shown in FIG. 4E. The receiver optics may be designed in such a way that the entire field of view is mapped onto the detector 400 (e.g., onto the APD row). For example, the optical array receiver 408 may be configured in such a way that it maps a respective sub-section of the field of view onto a detector pixel 402 (e.g., is assigned to the sub-section). For example, the optical array receiver 408 may be arranged between the detector 400 and a coarse angle control element of a LIDAR system (e.g., coarse angle control element 118). The optical array receiver 408 may have one or more lenses (e.g., one or more focusing lenses). In the example configuration of FIG. 4E, the optical array receiver 408 may have a lens 410 to focus light onto the detector 400 (e.g., in the vertical and horizontal directions). The lens 410 may have an equal focal length in the horizontal and vertical directions, for example of 57 mm.

FIGS. 5A, 5B, and 5C each show a LIDAR system 500 in a schematic representation. The LIDAR system 500 may be an example implementation of LIDAR system 100. Only one optical element (e.g., a multi-lens array) is shown on the emitter side in FIGS. 5B and 5C, but it is understood that other optical elements may also be present (e.g., a slow-axis collimator lens and/or a fast-axis collimator lens).

In the example configuration of FIG. 5A, the LIDAR system 500 may have a detector 502 on the receiver side. The detector may have, for example, 64 detector pixels (e.g., 64 channels) arranged in the horizontal direction, e.g., an array with 64 avalanche photodiodes. The LIDAR system 500 may further have receiver optics 504, e.g., a lens (e.g., a focusing lens), on the receiver side to direct (e.g., focus) light onto the detector 502. The LIDAR system 500 may have a laser module 506 on the emitter side, e.g., a laser bar with 8 laser diodes arranged in the vertical direction. The LIDAR system 500 may have emission optics in order to collimate the light emitted by the laser module 506. For example, the LIDAR system 500 may have a first collimator lens 508 (e.g., a fast-axis collimator lens) and a second collimator lens 510 (e.g., a slow-axis collimator lens). The LIDAR system 500 may have a coarse angle control element 512, such as a liquid crystal polarization grating, at the angle control stage. As a numerical example only, the liquid crystal polarization grating may have a horizontal direction size (e.g., a width) of about 50 mm and a vertical direction size (e.g., a height) of about 50 mm.

In the exemplary configuration in FIG. 5B, the LIDAR system 500 may have a detector 514 on the receiver side, e.g., a 1D detector row with 32 or 64 detector pixels (e.g., 32 or 64 avalanche photodiodes) arranged in the horizontal direction. The LIDAR system 500 may further have receiver optics 516 on the receiver side to direct light onto the detector 514. The receiver optics 516 may be configured in such a way that light from a tile 518 (e.g., an LCPG tile) is mapped onto the detector 514. The sub-sections of the tile 518 (which are arranged along the horizontal direction) are mapped by the receiver optics 516 onto the respective detector pixels. For example, the striped sub-section 518-1 may be mapped onto the striped detector pixel 514-1 (e.g., onto the APD cell). The tile 518 may, for example, have an angular extension of 7.5° in the horizontal direction and 4° in the vertical direction. The LIDAR system 500 may have a laser module 520 on the emitter side, e.g., a laser bar (e.g., a 1D emitter column) with 16 laser diodes arranged in the vertical direction (e.g., a 16-fold laser bar). The LIDAR system 500 may have a multi-lens array 522 to direct the light emitted by the laser module 520 into the field of view. The multi-lens array 522 may be configured such that light from each laser diode of the laser module 520 illuminates a respective sub-section of the tile 518 (among the sub-sections arranged along the vertical direction) (e.g., sub-section 518-2).

The LIDAR system 500 in FIG. 5C may have the same components of the system in FIG. 5B in a reversed configuration. In the configuration in FIG. 5C, the detector may have 514 detector pixels arranged in the vertical direction. The laser module 520 (and the multi-lens array 522) may be arranged in the horizontal direction. The arrangement of the sub-sections of the tile 518 may be reversed accordingly. The tile 518 may, for example, have an angular extension of 4° in the horizontal direction and 6° in the vertical direction.

The LIDAR system 500 may further have, on the emitter side, a slow-axis collimator lens and a fast-axis collimator lens, for example, arranged as shown in FIGS. 3G, 3H, and 5A, which are not shown in FIGS. 5B and 5C for the sake of clarity.

LIST OF REFERENCE NUMBERS

| | |
|---|---|
| LIDAR system | 100 |
| Field of view | 102 |
| Detector | 104 |
| Detector pixel | 106 |
| Optical axis | 108 |
| Light source | 110 |
| Sub-light source | 112 |
| Coarse angle control element | 114 |
| Tile | 116 |
| First tile | 116-1 |
| Second tile | 116-2 |
| Light emission controller | 118 |
| Direction | 152 |
| Direction | 154 |
| Direction | 156 |
| Coarse angle control element | 200 |
| Field of view | 202 |
| First tile | 202-1 |
| Second tile | 202-2 |
| Angle controller | 204 |
| Light source | 300 |
| Sub-light source | 302 |
| Field-of-view tile | 304 |
| Sub-section | 306 |
| Light emission system | 310 |
| Light emission controller | 312 |
| Optical array transmitter | 314 |
| Collimator lens | 316 |
| Collimator lens | 318 |
| Multi-lens array | 320 |
| Zone | 320-1 |
| Zone | 320-2 |
| Insertion | 322 |
| Detector | 400 |
| Detector pixel | 402 |
| Field-of-view tile | 404 |
| Sub-section | 406 |
| Receiver optics array | 408 |
| Lens | 410 |
| LIDAR system | 500 |
| Detector | 502 |
| Receiver optics | 504 |
| Laser module | 506 |
| Collimator lens | 508 |
| Collimator lens | 510 |
| Coarse angle control element | 512 |
| Detector | 514 |
| Detector pixel | 514-1 |
| Receiver optics | 516 |
| Tile | 518 |
| Sub-section | 518-1 |
| Sub-section | 518-2 |
| Laser bar | 520 |
| Multi-lens array | 522 |
| Control signal | S1 |
| Control signal | S2 |

1. A LIDAR system (100) having:
a detector (104) which is configured in such a way that it detects light from a field of view (102),
wherein the detector (104) has a plurality of detector pixels (106) arranged along a first direction,
wherein each detector pixel (106) of the plurality of detector pixels (106) may be assigned to a respective sub-section of the field of view (102),
a light source (110) having a plurality of sub-light sources (112) which are configured in such a way that they emit light into the field of view (102),
wherein the sub-light sources (112) of the plurality of sub-light sources (112) are arranged along a second direction at an angle to the first direction,
wherein each sub-light source (112) of the plurality of sub-light sources (112) is assigned to a respective sub-section of the field of view (102),
a coarse angle control element (114) arranged to deflect light from the light source (110) to the field of view and to deflect light from the field of view (102) to the detector (104), and
• a light emission controller (118) which is configured to control the sub-light sources (112) of the plurality of sub-light sources (112) in such a way that each sub-light source (112) of the plurality of sub-light sources (112) emits light in a respective emission time period.

2. The LIDAR system (100) according to claim 1,
wherein the second direction is perpendicular to the first direction.

3. The LIDAR system (100) according to claim 1 or 2,
wherein the coarse angle control element (114) is configured to deflect light from the light source (110) at a first deflection angle in order to illuminate a section of the field of view (102), and/or
wherein the coarse angle control element (114) is configured to deflect light from the field of view (102) at a second deflection angle in order to deflect light from a section of the field of view (102) onto the detector (104).

4. The LIDAR system (100) according to any of claims 1 to 3,
wherein the plurality of sub-light sources (112) has a first sub-light source and a second sub-light source, and
wherein the light emission controller (118) is configured to control the first sub-light source and the second sub-light source such that the first sub-light source emits light in a first emission time period and the second sub-light source emits light in a second emission time period,
wherein a waiting time between the first emission time period and the second emission time period is greater than or substantially equal to a maximum transit time of the emitted light.

5. The LIDAR system (100) according to any of claims 1 to 4, further having:
an angle controller (204) which is configured to control one or more light deflection properties of the coarse angle control element (114) to define a deflection angle of the deflected light.

6. The LIDAR system (100) according to claim 5,
wherein the coarse angle control element (114) is or has a liquid crystal polarization grating,
wherein the angle controller (204) is arranged to provide a control signal to the liquid crystal polarization grating in order to control an alignment of the liquid crystal molecules, wherein the alignment of the liquid crystal molecules defines a grating period of the liquid crystal polarization grating.

7. The LIDAR system (100) according to claim 5,
wherein the coarse angle control element (114) has a liquid crystal layer and a polarization grating,
wherein the angle controller (204) is configured to provide a control signal to the liquid crystal layer in order to control an alignment of the liquid crystal molecules of the liquid crystal layer, wherein the alignment of the liquid crystal molecules defines the polarization of light propagating through the liquid crystal layer.

8. The LIDAR system (100) according to any of claims 1 to 7,
wherein the light source (110) has at least one laser light source.

9. The LIDAR system (100) according to any of claims 1 to 8,
wherein the detector (104) has at least one photodiode configured to generate an electrical signal when light strikes the at least one photodiode.

10. The LIDAR system (100) according to any of claims 1 to 9, further having:
a optical array receiver (408) configured to receive light from the field of view and to direct the received light onto the detector (104), and/or
an optical array transmitter (314) configured to receive light from the light source (110) and to direct the received light onto the coarse angle control element (114),
wherein, optionally, the optical array transmitter (314) has a multi-lens array for mixing the light emitted by each sub-light source of the plurality of sub-light sources.
